(19) United States
(12) Patent Application Publication
(10) Pub. No.: US 2005/0066334 A1
(43) Pub. Date: Mar. 24, 2005

(54) Method and system for monitoring communication and monitoring protocol

(76) Inventors: Jarmo Ruusiala, Tampere (FI); Juuka Syrjanen, Tampere (FI); Jyrki Hokkanen, Tampere (FI); Mika Korpela, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/831,319

(22) Filed: Apr. 26, 2004

(30) Foreign Application Priority Data
Sep. 18, 2003 (FI) 20031340

(51) Int. Cl. G06F 9/46

(52) U.S. Cl. 719/310

(57) ABSTRACT

A method, system and monitoring protocol for monitoring of software processes when communications other than network interfaces are used during communication in a mobile telecommunication system. In the invention monitoring data is captured in at least one process and serialized. The monitoring data is then encapsulated to at least one data packet and sent to a monitoring endpoint outside the at least one process. A monitoring tool captures the monitoring data from the monitoring endpoint and processes it further.

### BACKGROUND OF THE INVENTION

1. Field of the Invention

The invention relates to mobile telecommunication systems. In particular, the invention relates to a novel and improved method and system for monitoring of software processes when communications other than network interfaces are used during communication in a mobile telecommunication system. Furthermore, a monitoring protocol is disclosed.

2. Description of the Related Art

Monitoring of communication messages between different entities (e.g. network elements, computer units, software components, processes etc.) has traditionally had an important role in tracking errors in communication network element software. The error tracking via monitoring is especially important when problems occur in a live network environment.

There are lots of tools for monitoring communication between processes. In general, they are based on the idea of capturing data sent/received via network interfaces. Therefore, traffic monitoring can be implemented at the network interface level. This is the most cost-effective way in terms of generality and avoidance of application involvement to the monitoring functionality. For the network interface level solutions, powerful and specific commercial monitoring tools are provided with which data communication using network interfaces can be monitored. Monitoring can be targeted based on e.g. specific IP (Internet Protocol) addresses, ports, protocols etc.

However, in high performance telecommunication applications, there can be a lot of functionality encapsulated inside a process (for performance reasons). Furthermore, entities within a process might do a lot of communication with each other. To ease development and troubleshooting, it is essential to be able to monitor also intra process communication flows.

Monitoring, e.g. error tracking and troubleshooting is commonly based on debugging, logging or tracing the execution with e.g. console printouts or file logging. These means are applicable at the development time when real-time execution speed is not an essential requirement. Unfortunally, these means are not applicable in the real live network environments or for troubleshooting when real time execution cannot be compromised.

Monitoring of processes not using transport network interfaces on the top of different network protocols is not possible using monitoring tools that are based on capturing data at the network interface level. When communicating parties reside in the same process or in more general, when communication does not utilize network interfaces (e.g. it is based on shared memory, UNIX sockets, global memory of a process etc.) such a monitoring approach cannot be used. In these cases messaging between processes or entities, e.g. objects is not done at the network interface level at all, and message monitoring cannot be implemented using conventional means.

Furthermore, monitoring of instance data of communicating objects essentially in real-time is not possible using the conventional monitoring software means. Instance data may also refer e.g. to the state indicating data in case when communicating objects are state machine objects.

### SUMMARY OF THE INVENTION

According to one embodiment of the invention, there is provided a method for monitoring of software processes when communications other than network interfaces are used during communication in a mobile telecommunication system. The method comprises the steps of capturing monitoring data in at least one process, serializing the monitoring data, encapsulating the serialized monitoring data to at least one data packet and sending at least one encapsulated data packet comprising the serialized monitoring data from the at least one process to a monitoring endpoint outside the at least one process.

In one embodiment, the method further comprises the steps of capturing the at least one encapsulated data packet sent to the monitoring endpoint with a monitoring application and resolving the monitoring data from the at least one encapsulated data packet.

In one embodiment, the monitoring data relates to communications comprising an inter process communication.

In another embodiment, the monitoring data relates to communications comprising an intra process communication.

In one embodiment, the monitoring data refers to at least one of the following pieces of information: state of the at least one process, a sent message or sent messages to at least one process, a received message or received messages with the at least one process, a sent message or sent messages to a predetermined receiver from the at least one process, a received message or messages from a predetermined sender with the at least one process, and a handled message or handled messages by the at least one process. In one embodiment, a handled message refers to a message that has been both received and dealt with. Furthermore, a received message refers to a message that has not yet been dealt with.

In one embodiment, the step of capturing comprises capturing monitoring data monitoring data of at least one object of the at least one process. The monitoring data may refer to at least one of the following pieces of information: state of the at least one object, instance data of the at least one object, a sent message or sent messages to the at least one object, a received message or received messages with the at least one object, a sent message or sent messages to a predetermined receiver from the at least one object, a received message or received messages from a predetermined sender with the at least one object, and a handled message or handled messages by the at least one object.

In one embodiment, the step of serializing comprising serializing the monitoring data using a definition language. The step of serializing comprises e.g. defining the monitoring data using a definition language or serializing the monitoring data using serialization code generated from a definition language. The definition language is e.g. the Object Management Group (OMG) Interface Definition Language.

In one embodiment, after the step of serializing the monitoring data, the method further comprises the step of encoding the monitoring data according to a monitoring protocol. The monitoring data may be encoded e.g. according to the General Inter Object Request Broker Protocol.

In one embodiment, the encoding of the monitoring data according the General Inter Object Request Broker Protocol comprises the step of reusing an Object key and Operation fields of a General Inter Object Request Broker Protocol Request Header of a General Inter Object Request Broker Protocol packet and a General Inter Object Request Broker Protocol Request body for carrying the monitoring data.

According to a second embodiment of the invention, there is provided a monitoring protocol for carrying monitoring data of processes of a mobile telecommunication system, wherein a monitoring protocol packet comprises at least the fields of a monitoring protocol header comprising at least fields of an identifier of a protocol used, message size, message identifier, information size and information, and a monitoring body comprising monitoring payload data.

In one embodiment, the monitoring body comprises monitoring data as a serialized byte stream. The serialized byte stream may be serialized using a definition language, e.g. the Interface Definition Language.

According to a third embodiment of the invention, there is provided a system for monitoring of software processes when communication other than network interfaces are used during communication in a mobile telecommunication system, wherein the system comprises capturing means for capturing monitoring data in at least one process, serializing means for serializing the monitoring data, encapsulating means for encapsulating the serialized monitoring data to at least one data packet, and sending means for sending at least one encapsulated data packet comprising the serialized monitoring data from the at least one process to a monitoring endpoint outside the at least one process.

In one embodiment, the system further comprises capturing means for capturing the at least one encapsulated data packet sent to the monitoring endpoint with a monitoring application, and resolving means for resolving the monitoring data from the at least one encapsulated data packet.

In one embodiment, the monitoring data relates to communications comprising an inter process communication.

In another embodiment, the monitoring data relates to communications comprising an intra process communication.

In one embodiment the monitoring data refers to at least one of the following pieces of information state of the at least one process, a sent message or sent messages to the at least one process, a received message or received messages with the at least one process, a sent message or sent messages to a predetermined receiver from the at least one process, a received message or received messages from a predetermined sender with the at least one process, and a handled message or handled messages by the at least one process.

In one embodiment, capturing means are configured to capture monitoring data of at least one object of the at least one process.

In one embodiment, the monitoring data refers to at least one of the following pieces of information state of the at least one object, instance data of the at least one object, a sent message or sent messages to the at least one object, a received message or received messages with the at least one object, a sent message or sent messages to a predetermined receiver from the at least one object, a received message received or messages from a predetermined sender with the at least one object, and a handled message or handled messages by the at least one object.

In one embodiment, serializing means are configured to serialize the monitoring data using a definition language, e.g. the Interface Definition Language.

In one embodiment, the system further comprises encoding means for encoding the monitoring data according to a monitoring protocol. Encoding means may be configured to encode the monitoring data according the General Inter Object Request Broker Protocol. Encoding means may be configured to encode the monitoring data according a General Inter Object Request Broker Protocol reusing an Object key and Operation key fields of a General Inter Object Request Broker Protocol Request Header of a General Inter Object Request Broker Protocol data packet and a General Inter Object Request Broker Protocol Request body for carrying the monitoring data.

The invention has several advantages over the prior-art solutions. The invention enables real-time error tracking and troubleshooting. Furthermore, the invention provides a solution with which is possible to monitor communication when network interfaces are not used as transport interfaces. If the monitoring functionality is implemented using a special library function, the messaging library encapsulates monitoring related communications from an application including the monitored processes or objects thus providing support for message monitoring transparent to the application.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a illustrates monitoring of communication between different processes in accordance with the invention,

FIG 1b illustrates monitoring of communication between different objects within a process in accordance with the invention,

FIG. 2 illustrates the message structure of a General Inter ORB Protocol (GIOP) message used in delivering monitoring information in accordance with the invention, and

FIG. 3 illustrates the message structure of a monitoring protocol message used in delivering monitoring information in accordance with the invention.

### DETAILED DESCRIPTION OF THE PREFERRED EMBODIMENTS

Reference will now be made in detail to the embodiments of the invention, examples of which are illustrated in the accompanying drawings.

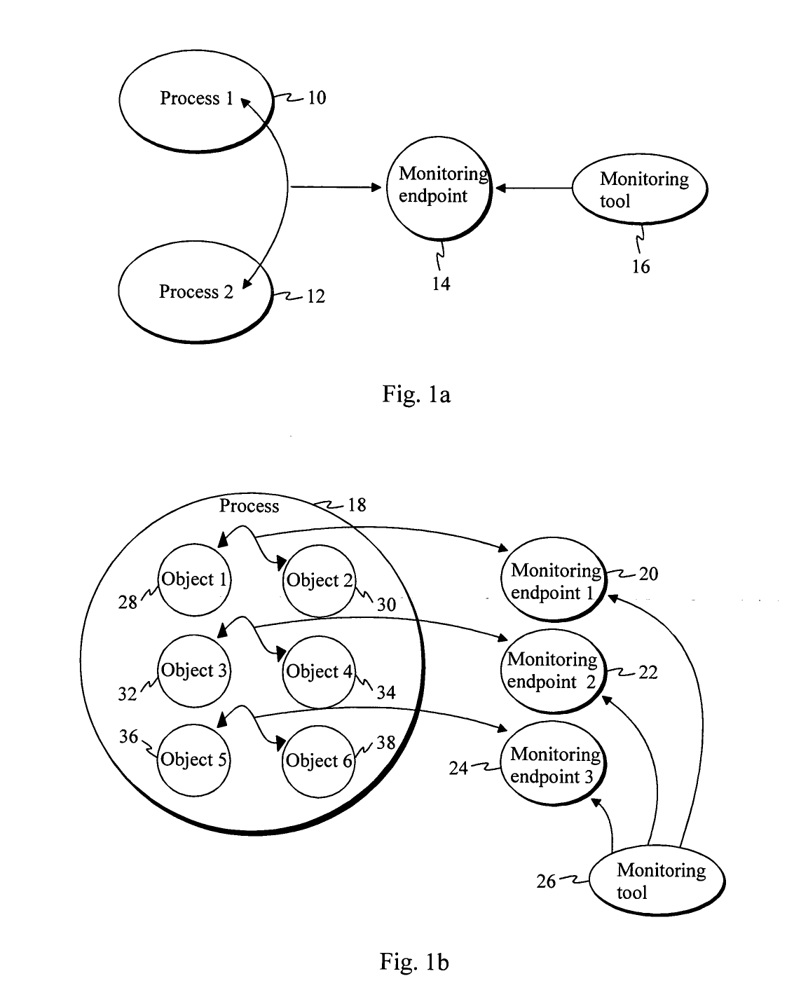

FIG 1a describes an embodiment of the invention in which communication between two processes 10, 12 is monitored. The monitoring data is sent to a monitoring endpoint 14. Monitoring endpoint 14 refers e.g. to a predefined IP (Internet Protocol) address, port etc. The wording ‘monitoring endpoint’ may also refer e.g. to file or shared memory segment to which monitoring data is written and from which a monitoring tool-is able to read the monitoring data. The application comprising processes 10, 12 may have several monitoring endpoints open at the same time (see. FIG. 1b); a dedicated endpoint for a dedicated purpose. A monitoring tool 16 then attaches itself to monitoring endpoint 14 and captures data sent to it. Monitoring tool 16 may be a commercially available monitoring tool, e.g. the Ethereal, or a proprietary monitoring tool. The Ethereal is a network protocol analyzer that allows examining data from a live network or from a capture file on a disk. Using the Ethereal it is possible to browse the captured data, view summary and detail information for each packet.

Although not disclosed in FIG 1a, processes 10 and 12 may include one or more objects that do the actual communication with other objects of processes.

Processes 10 and 12 in FIG 1a do not use network interfaces for software communication but e.g. a shared memory, UNIX sockets etc.). In one embodiment of FIG. 1a, monitoring messages are defined using a definition language, e.g. the Common Object Request Broker Architecture (CORBA) Interface Definition Language (IDL). If a definition language is used, a plugin (for the monitoring tool) can be generated based on the IDL. The generated plug-in is able to decode the encoded monitoring data. Therefore, to encode e.g. a General Inter ORB Protocol (GIOP) packet, e.g. the CORBA IDL compiler generated serializing routines can be used. For other types of messages, e.g. messages defined as C++ classes, application designers have to write serializing routines for messages. Monitoring data is sent as encoded GIOP data on the top of the User Data Protocol (UDP). It is possible to use any other appropriate protocol, e.g. the Internet Protocol (IP), as an underlying protocol.

FIG. 1b describes an embodiment of the invention in which communication between software objects is monitored. FIG. 1b illustrates a process 18 comprising several software objects 28-38. The communication between each object pair is monitored, and monitoring data is sent to a monitoring endpoint. In FIG. 1b, monitoring data related to communication between objects 28 and 30 is sent to a monitoring endpoint 20. Correspondingly, monitoring data related to communication between objects 32 and 34 is sent to a monitoring endpoint 22. Furthermore, monitoring data related to communication between objects 36 and 38 is sent to a monitoring endpoint 24. Monitoring endpoints 20-24 refers e.g. to predefined IP (Internet Protocol) addresses, ports etc. A monitoring tool 26 then attaches itself to monitoring endpoints 20-24 and captures data sent to them. Monitoring tool 26 may be a commercially available monitoring tool, e.g. Ethereal, or a proprietary monitoring tool.

In one embodiment of FIG. 1b, monitoring messages are defined using a definition language, e.g. the Common Object Request Broker Architecture (CORBA) Interface Definition Language (IDL). If a definition language is used, a plug-in (for the monitoring tool) can be generated based on the IDL. The generated plugin is able to decode the encoded monitoring data. Therefore, to encode e.g. a General Inter ORB Protocol (GIOP) packet, e.g. the CORBA IDL compiler generated serializing routines can be used. For other types of messages, e.g. messages defined as C++ classes, application designers have to write serializing routines for messages. Monitoring data is sent as encoded GIOP data on the top of the User Data Protocol (UDP). It is possible to use any other appropriate protocol, e.g. the Internet Protocol (IP), as an underlying protocol.

The solutions disclosed in FIGS 1a and 1b enable a very efficient way to monitor communication e.g. between processes or objects. Monitoring information may relate e.g. to sent message or messages to the process, received message or messages with the process, sent message or messages to a predetermined receiver from the process, received message or messages from a predetermined sender with the process or handled message or messages by the process. In addition monitoring may relate to a state of a process. If monitoring is applied to communication between objects, monitoring information may relate e.g. to sent message or messages to the object, received message or messages with object, sent message or messages to a predetermined receiver from the object, received message or messages from a predetermined sender with the object, or handled message or messages by the object. In addition monitoring information may relate to a state of an object or instance data of the object. In practice, communication between processes generally means the same as communication between objects of one process or between objects of different processes. The processes may be in the same computer unit. Alternatively, they may be distributed in different computer units.

In one embodiment of FIGS. 1a and 1b, the monitoring functionality is implemented using a special library function. Therefore, the system may comprise e.g. generic messaging interfaces (e.g. ReceiveMessage, SendMessage) with which the sending of monitoring data to a monitoring channel (endpoint) as well as initialization (opening) of the channel can be made transparent to applications. The messaging library encapsulates monitoring related communications from an application thus providing support for message monitoring transparent to the application. An application here refers e.g. to the application including the monitored processes or objects.

The library function also enables the definition of rules and definitions determining e.g. which messages, objects and processes are monitored.

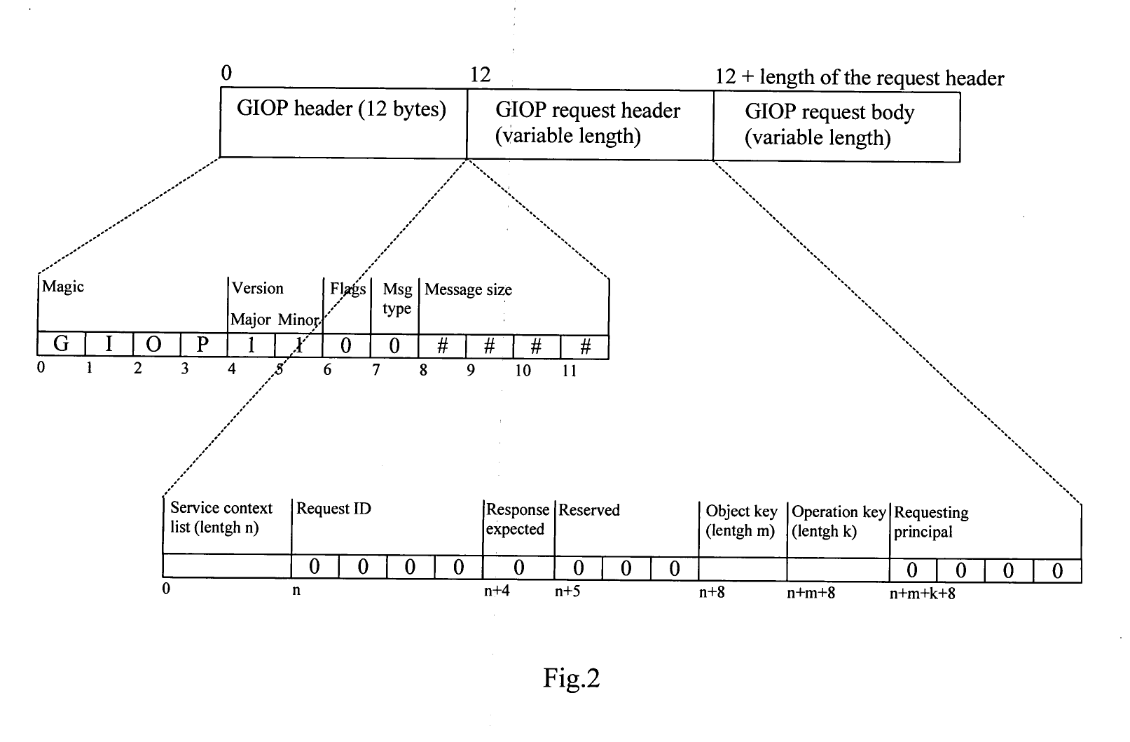

FIG. 2 illustrates the message structure of a GIOP message used in delivering monitoring information. The message structure of a basic General Inter ORB Protocol (GIOP) includes a GIOP header, a GIOP request header and a GIOP request body. The GIOP request body refers to payload information wherein the monitoring data is as a serialized byte stream.

The 12-byte GIOP header is formed as illustrated in the following:
Magic: Contains always characters GIOP. This indicates that the message is a GIOP message.
Version: Major and minor version numbers of the GIOP protocol version in use, e.g. 1.1.
Flags: bits 7 6 5 4 3 2 1 0, where
   Bit 0
      0: Big endian encoding for the rest of the message.
      1: Little endian encoding for the rest of the message.
   Bit 1
      Message is a fragment messages with more to follow.
      Message is a complete message or the last message in a sequence of fragments.
   Other bits are reserved for future usage.
Message type:
   Indicates the type of the message format following the GIOP header
   0: Request; 1: Reply; 2: CancelRequest; 3: LocateRequest; 4: LocateReply; 5: CloseConnection; 6: MessageError; 7: Fragment.
   The invention may use value 0 (Request).
Message size: The size of the rest of the message (excluding the 12-byte GIOP header). The value is encoded as big or little endian as indicated with the 0 bit of the flags byte.

The GIOP header is of variable length. In the following only those fields of the GIOP Request header that are relevant in view of the invention are described, i.e. Object key and Operation key fields:
Object key: In the monitoring purpose in accordance with the invention, this field is used to carry additional monitoring information. The format of the field can be e.g.
XXXX <event> to YYYY at hh:mm:ss, where
   XXXX=message identifier
   event=received or handled
   YYY=receiver identifier
XXXX sent from ZZZZ to YYYY where
   XXXX=message identifier
   YYYY=receiver identifier
   ZZZZ=sender identifier
Or for instance data: Instance data of XXXX at hh:mm:ss where
   XXXX=Identifier of the instance data owner.
Operation: The name of the message/operation. In monitoring, this field is used to select the correct plug-in in a monitoring tool.

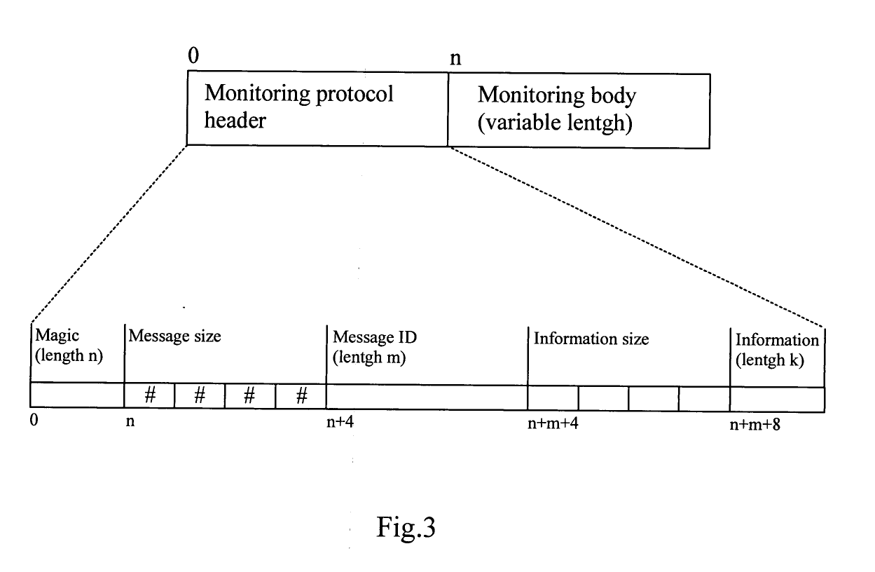

FIG. 3 illustrates an example of the message structure of a monitoring protocol message that can be used in delivering monitoring information in accordance with the invention instead of the GIOP. The message structure includes a monitoring protocol header and a monitoring body. The monitoring body refers to payload information wherein the monitoring data is as a serialized byte stream.

The n-byte monitoring protocol header is formed as illustrated in the following:
Magic: The identifier of the protocol. Length n bytes.
Message size: The total size of the message. Length 4 bytes.
Message ID: 4 to 8-byte identifier for the monitored message. This field is used to select the correct plug-in in a monitoring tool.
Information size: Length of the following freeform information text.
Information: Freeform information text. In the monitoring purpose in accordance with the invention, this field is used to carry additional monitoring information. The format of the field can be e.g. XXXX <event> to YYYY at hh:mm:ss, where
   XXXX=message identifier
   event=sent or received
   YYYY=receiver identifier, e.g. a process identifier.

The described monitoring protocol is more efficient than if the GIOP is used to carry monitoring data.

It is obvious to a person skilled in the art that with the advancement of technology, the basic idea of the invention may be implemented in various ways. The invention and its embodiments are thus not limited to the examples described above, instead they may vary within the scope of the claims.

1. A method for monitoring of software processes when communications other than network interfaces are used during communication of said software processes in a mobile telecommunication system, the method comprising the steps of:
capturing monitoring data in at least one process;
serializing said monitoring data;
encapsulating said serialized monitoring data to at least one data packet; and
sending at least one encapsulated data packet comprising said serialized monitoring data from said at least one process to a monitoring endpoint outside said at least one process.

2. The method according to claim 1, further comprising the steps of:
capturing said at least one encapsulated data packet sent to said monitoring endpoint with a monitoring application; and
resolving said monitoring data from said at least one encapsulated data packet.

3. The method according to claim 1, comprising monitoring data related to communications comprising an inter process communication.

4. The method according to claim 1, comprising monitoring data related to communications comprising an intra process communication.

5. The method according to claim 1, wherein said capturing comprises capturing said monitoring data by referring to at least one of the following pieces of information:
state of said at least one process;
a sent message or sent messages to said at least one process;
a received message or received messages with said at least one process;
a sent message or sent messages to a predetermined receiver from said at least one process;
a received message or messages from a predetermined sender with said at least one process; and
a handled message or handled messages by said at least one process.

6. The method according to claim 1, wherein said step of capturing comprises capturing monitoring data of at least one object of said at least one process.

7. The method according to claim 6, wherein said step of capturing comprises capturing said monitoring data by referring to at least one of the following pieces of information:
state of said at least one object;
instance data of said at least one object;
a sent message or sent messages to said at least one object;
a received message or received messages with said at least one object;
a sent message or sent messages to a predetermined receiver from said at least one object;
a received message or received messages from a predetermined sender with said at least one object; and
a handled message or handled messages by said at least one object.

8. The method according to claim 1, wherein said step of serializing comprises serializing said monitoring data using a definition language.

9. The method according to claim 8, wherein said step of serializing comprises serializing using said definition language comprising an Interface Definition Language.

10. The method according to claim 1, wherein after said step of serializing said monitoring data, the method further comprising the step of:
encoding said monitoring data according to a monitoring protocol.

11. The method according to claim 10, said step of encoding comprises encoding said monitoring data according to a General Inter Object Request Broker Protocol.

12. The method according to claim 11, wherein said step of encoding said monitoring data according to the General Inter Object Request Broker Protocol comprising the step of:
reusing an Object key and Operation key fields of a General Inter-Object Request Broker Protocol Request Header of a General Inter-Object Request Broker Protocol data packet and a General Inter-Object Request Broker Protocol Request body for carrying said monitoring data.

13. A monitoring protocol for carrying monitoring data of processes of a mobile telecommunication system, wherein a monitoring protocol packet comprises at least the fields of:
a monitoring protocol header comprising at least fields of an identifier of a protocol used, message size, a message identifier, information size and information; and
a monitoring body comprising monitoring payload data.

14. The monitoring protocol according to claim 13, wherein said monitoring body comprises monitoring data as a serialized byte stream.

15. The monitoring protocol according to claim 14, wherein said serialized byte stream is serialized using a definition language.

16. The monitoring protocol according to claim 15, wherein said definition language comprises an Interface Definition Language.

17. A system for monitoring of software processes when communications other than network interfaces are used during communication of said software processes in a mobile telecommunication system, the system comprising:
capturing means for capturing monitoring data in at least one process;
serializing means for serializing said monitoring data;
encapsulating means for encapsulating said serial ized monitoring data to at least one data packet; and
sending means for sending at least one encapsulated data packet comprising said serialized monitoring data from said at least one process to a monitoring endpoint outside said at least one process.

18. The system according to claim 17, further comprising:
capturing means for capturing said at least one encapsulated data packet sent to said monitoring endpoint with a monitoring application; and
resolving means for resolving said monitoring data from said at least one encapsulated data packet.

19. The system according to claim 17, wherein said monitoring data relates to communications comprising an inter process communication.

20. The system according to claim 17, wherein said monitoring data relates to communications comprising an intra process communication.

21. The system according to claim 17, wherein said monitoring data refers to at least one of the following pieces of information:
state of said at least one process;
a sent message or sent messages to said at least one process;
a received message or received messages with said at least one process;
a sent message or sent messages to a predetermined receiver from said at least one process;
a received message or received messages from a predetermined sender with said at least one process; and
a handled message or handled messages by said at least one process.

22. The system according to claim 17, wherein said capturing means are configured to capture monitoring data of at least one object of said at least one process.

23. The system according to claim 22, wherein said monitoring data refers to at least one of the following pieces of information:
state of said at least one object;
instance data of said at least one object;
a sent message or sent messages to said at least one object;
a received message or received messages with said at least one object;
a sent message or sent messages to a predetermined receiver from said at least one object;
a received message or received messages from a predetermined sender with said at least one object; and
a handled message or handled messages by said at least one object.

24. The system according to claim 17, wherein said serializing means are configured to serialize said monitoring data using a definition language.

25. The system according to claim 24, wherein said definition language comprises an Interface Definition Language.

26. The system according to claim 17, the system further comprising:
encoding means for encoding said monitoring data according to a monitoring protocol.

27. The system according to claim 26, wherein said encoding means are configured to encode said monitoring data according to a General Inter Object Request Broker Protocol.

28. The system according to claim 27, wherein said encoding means are configured to encode said monitoring data according the General Inter Object Request Broker Protocol reusing an Object key and Operation key fields of the a General Inter-Object Request Broker Protocol Request Header of a General Inter-Object Request Broker Protocol data packet and a General Inter-Object Request Broker Protocol Request body for carrying said monitoring data.
